(19) United States
(12) Patent Application Publication
(10) Pub. No.: US 2025/0357892 A1
(43) Pub. Date: Nov. 20, 2025

(54) BIFACIAL PHOTOVOLTAIC DEVICE TEST METHOD

(71) Applicant: Electric Power Research Institute, Inc., PALO ALTO, CA (US)

(72) Inventors: Mason J. REED, Perry Hall, MD (US); James A. RAND, Landenberg, PA (US); Wayne LI, Fulton, MD (US); Devin WIDRICK, Charlotte, NC (US); Robert FLOTTEMESCH, Baltimore, MD (US)

(21) Appl. No.: 19/207,571

(22) Filed: May 14, 2025

Related U.S. Application Data
(60) Provisional application No. 63/647,580, filed on May 14, 2024.

(51) Int. Cl. H02S 50/10; H02S 20/10; H02S 40/20

(52) U.S. Cl. CPC H02S 50/10; H02S 20/10; H02S 40/20

(57) ABSTRACT

An in-situ method for measuring the power delivery performance of a bifacial photovoltaic device installed in the field. The method utilizes a substantially non-reflective material layer applied to the rear side of the bifacial photovoltaic panel to minimize or eliminate the contribution from irradiance directed to the rear side of the bifacial photovoltaic panel. The use of the substantially non-reflective material layer on the rear side of the panel enables in situ measurements of the power delivery performance of field installed photovoltaic panels that more closely approximates the power delivery performance of the front side of the photovoltaic panel.

This application claims the benefit of the filing date under 35 U.S.C. § 119 (e) of United States Provisional Application For Patent Ser. No. 63/647,580, filed May 13, 2024, which is hereby incorporated by reference in its entirety.

### TECHNICAL FIELD

Disclosed is a method for measuring the power delivery performance of a photovoltaic cell, module, panel, or array. The disclosure more particularly relates to a method for measuring the power delivery performance of a bifacial photovoltaic cell, module, panel, or array, and a test apparatus for measuring the power delivery performance of a bifacial photovoltaic cell, module, panel or array.

### BACKGROUND

Modern photovoltaic panels are sold and warranted according to the power delivered by the panel under a strict set of environmental conditions. Many modern photovoltaic panels are bifacial photovoltaic panels that accept light from the front and rear sides of the bifacial panel. The maximum power delivery performance of the front current-voltage (I-V) curve measured at the factory is how the manufacturer selects what power rating is listed on the bifacial photovoltaic panel, and it is the front side power delivery performance of the panel that is typically warranted by the manufacturer. However, it is difficult to eliminate the contribution to power delivery from the rear side of a bifacial photovoltaic panel, except through a carefully built laboratory test station.

The International Electrotechnical Commission's (“IEC”) technical standard 60904-1-2:2019 entitled, “Measurement of Current-Voltage Characteristics of bifacial photovoltaic (PV) device” describes methods and test setup for measuring the current-voltage (I-V) characteristics of bifacial photovoltaic panels in natural or simulated sunlight. According to the IEC standard, to measure the I-V characteristics of both the front and rear surfaces of bifacial devices, the contribution from the light incident on the opposite side of the device under test shall be eliminated completely during the measurement by creating a non-reflective background.

The IEC's photovoltaic panel test setup is shown in FIG. 1. The test setup includes baffles positioned along the margins of a bifacial photovoltaic array to prevent passage of light from the front side of the array beyond the plane of the array and a non-reflective material positioned behind the photovoltaic array to reduce reflection of light onto the rear side of the array. The test setup is designed to suppress irradiance to 3 W/m² on the non-exposed rear side of the bifacial photovoltaic array before measuring the I-V curve of the front side of the array.

What is needed in the art is a test method for more accurately measuring the power delivery performance of a bifacial photovoltaic panel that is installed in the field or in a general photovoltaic panel test station.

### SUMMARY OF ILLUSTRATIVE EMBODIMENTS

According to a first illustrative embodiment, provided is an in-situ method for measuring the power delivery performance of a field installed bifacial photovoltaic device having a front surface and a rear surface, the method comprising attaching a detachable substantially non-reflective layer on the rear surface of the field installed bifacial photovoltaic device; and measuring the power delivery performance of the field installed bifacial photovoltaic device.

According to a second illustrative embodiment, provided is an in-situ method for measuring the power delivery performance of a field installed bifacial photovoltaic device having a front surface and a rear surface, the method comprising attaching a detachable substantially non-reflective layer on the rear surface of the field installed bifacial photovoltaic device; measuring the in-situ power delivery performance of the field installed bifacial photovoltaic device, and comparing the in-situ measured power delivery performance of the field installed bifacial photovoltaic device to the power delivery performance of the bifacial photovoltaic device measured at a manufacturing facility prior to the device being installed in the field.

According to a third illustrative embodiment, disclosed is a test apparatus provided for in-situ measuring the power delivery performance of a field installed bifacial photovoltaic device having a front surface and a rear surface, the apparatus comprising a field installed bifacial photovoltaic cell, module, panel, or array having a front side and a rear side opposite the front side, a detachable substantially non-reflective layer attached to the rear side of the field installed bifacial photovoltaic cell, or to a portion of the rear side of the bifacial module, panel or array, and at least one irradiance sensor.

According to a fourth illustrative embodiment, disclosed is a bifacial photovoltaic device comprising a bifacial photovoltaic cell, module, panel, or array having a front side and a rear side opposite the front side, a detachable substantially non-reflective layer attached to the rear side of the bifacial photovoltaic cell, or to a portion of the rear side of the bifacial module, panel or array, and at least one irradiance sensor.

According to a fifth illustrative embodiment, disclosed is a field installed photovoltaic device comprising a bifacial photovoltaic cell, module, panel, or array having a front side and a rear side opposite the front side, a detachable substantially non-reflective layer attached to the rear side of the bifacial photovoltaic cell, or to a portion of the rear side of the bifacial module, panel or array, and at least one irradiance sensor.

### BRIEF DESCRIPTION OF THE DRAWINGS

FIG. 1 is a schematic representation of the test setup described in the International Electrotechnical Commission's (“IEC”) technical standard 60904-1-2:2019 entitled, “Measurement of Current-Voltage Characteristics of bifacial photovoltaic (PV) device,” describes methods and test setup for measuring the current-voltage (I-V) characteristics of bifacial photovoltaic panels.

FIG. 2 is a rear perspective view of a bifacial photovoltaic module installed in the field with the presently disclosed substantially non-reflective material layer applied to the rear side of a portion of the bifacial photovoltaic module.

FIG. 3 is a schematic depiction of the transmission of front side irradiance passing between adjacent photovoltaic cells of a photovoltaic module or panel, and through photovoltaic cells and out of the rear surface of a bifacial photovoltaic module.

FIG. 4 is a graph showing the fraction of irradiance transmitted between photovoltaic cells and out of the rear surface of a bifacial photovoltaic module without a white mesh on the backsheet of the photovoltaic module as a function of incidence angle.

FIG. 5 is a graph of the spectral irradiance incident upon the silicon wafer of a photovoltaic cell and the spectrum of light expected to re-enter the silicon wafer of the cell if all light transmitted through the silicon wafers were re-directed into the photovoltaic module. The normalized spectral response of a silicon photovoltaic cell is also shown.

FIG. 6 is a graph of the total hemispheric reflectance of different substantially non-reflective materials.

FIG. 7A is a schematic representation of a laboratory setup to simulate the field conditions of a bifacial photovoltaic device with its rear surface exposed and using a baffle structure to prevent transmission of irradiance to the rear surface of the device.

FIG. 7B is a schematic representation of a laboratory to simulate the field conditions of a bifacial photovoltaic device with its rear surface exposed and using a rear side reflector to direct irradiance onto the rear surface of the device.

FIG. 7C is a schematic representation of a laboratory setup to simulate the field conditions of an illustrative embodiment of the bifacial photovoltaic device with its rear surface with a rear side reflector and with a substantially non-reflective layer or surface applied to the rear surface of the bifacial photovoltaic device.

FIG. 8 is a graph showing the I-V curve characteristics of a photovoltaic module at standard testing conditions (STC) collected in accordance with the laboratory setups of FIGS. 7A, 7B and 7C.

FIG. 9 is a bar graph showing the ratio of the electrical parameters Voc, Isc, Pmp, Vmp and Imp measured in accordance with the laboratory setups of FIGS. 7B and 7C as compared to the electrical parameters measured in accordance with the laboratory setup of FIG. 7A (simulation of a manufacturer's factory I-V curve setup). Values above 100% indicate an increase relative to the factory test conditions. Values below 100% indicate a decrease relative to factory test conditions.

FIG. 10A is a schematic representation of a bifacial photovoltaic module with a white mesh pattern printed on a rear transparent backsheet or rear glass in the areas between cells.

FIG. 10B is a schematic representation of a bifacial photovoltaic module without a white mesh pattern printed on a rear transparent backsheet or rear glass in the areas between cells.

FIG. 11A is a schematic representation of the setup condition used for Example 4 of a bifacial photovoltaic device installed and operating in the field and having both its front and rear surfaces exposed. This is referred to as the bifacial condition for measuring the Bifacial IV Curve.

FIG. 11B is a schematic representation of the setup condition used for Example 4 of a bifacial photovoltaic device installed and operating in the field with only its rear surface exposed. This is referred to as the frontside-only condition for measuring the Frontside-only IV Curve.

FIG. 11C is a schematic representation of the setup condition used for Example 4 of the Instrumented Reference Module installed and operating in the field with only its rear surface exposed. The irradiance sensor module is mounted on the front side of the module and the temperature sensor is mounted on the back or rear side of the module.

FIG. 12A is a graph showing the STC performance of photovoltaic modules based on the Bifacial I-V Curve measurements using the rear side irradiance and temperature adjustment values calculated by Equations 1 and 2 set forth in Table 3.

FIG. 12B is a graph showing the STC performance of photovoltaic modules based on the Frontside-only I-V Curve measurements using the rear side irradiance and temperature adjustment values calculated by Equations 1 and 2 set forth in Table 3.

### DETAILED DESCRIPTION OF ILLUSTRATIVE EMBODIMENTS

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The terms “comprises,” “comprising,” “has,” “having,” “includes,” “including,” “contains,” “containing,” or any other variation are open-ended and are intended to cover a non-exclusive inclusion of elements, such that an article, apparatus, compound, composition, combination, method, or process that “comprises,” “has,” or “includes,” or “contains” a recited list of elements does not include only those elements but may include other elements not expressly listed, recited or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more than one unless expressly stated otherwise or constrained by other language herein. An element or feature proceeded by “a” or “an” may be interpreted as one of the recited element or feature, or more than one of the element or feature.

As used in the present specification, the term “or” refers to an inclusive “or” and not to an exclusive “or”. For example, the phrase “A or B” is satisfied by any one of the following: A is present (element or method step) and B is not present (element or method step), A is not present (element or method step) and B is present (element or method step), and both A and B are present (element or process step).

As used in this specification any reference to the phrases “one embodiment” or “an embodiment” means that a particular element, feature, structure, process step, or characteristic described in connection with the embodiment is included in at least one embodiment. The particular element, feature, structure, process step, or characteristic may, in fact, be included in more than one embodiment disclosed herein. Furthermore, the use of the phrase “in one embodiment” in various places in the specification does not necessarily all refer to the same embodiment.

As used in the present specification, any of the terms “preferably,” “commonly,” and “typically” are not intended to, and do not, limit the presently disclosed, method, uses, and apparatus, or to imply that certain features are critical, essential, important, or required to the structure or function of the method, uses, or apparatus. Rather, these terms are merely intended to identify particular aspects of an embodiment or to emphasize alternative or additional features that may or may not be utilized in a particular embodiment.

Disclosed is an in-situ method of measuring the power delivery performance of a bifacial photovoltaic device. According to certain embodiments, disclosed is an in-situ method of measuring the power delivery performance of a bifacial photovoltaic device having a front surface and a rear surface that is installed in the field. According to certain embodiments, disclosed is an in-situ method of measuring the power delivery performance of a bifacial photovoltaic device having a front surface and a rear surface that is installed in the field and operating under normal operating conditions. The method comprises attaching a detachable substantially non-reflective material layer or surface on at least a portion of the rear surface of the bifacial photovoltaic device that is installed in the field and measuring the power delivery performance of the bifacial photovoltaic device by collecting I-V curve measurements. According to certain embodiments, disclosed is an in-situ method of measuring the power delivery performance of a bifacial photovoltaic device having a front surface and a rear surface that is installed and operating in the field. According to certain embodiments, disclosed is an in-situ method of measuring the power delivery performance of a bifacial photovoltaic device having a front surface and a rear surface that is installed in the field and operating under normal operating conditions.

The method of measuring the power delivery performance of a bifacial photovoltaic device may be used to collected I-V curve measurements of a wide range of photovoltaic devices including, without limitation, single photovoltaic cells, photovoltaic modules that comprise more than one photovoltaic cell, or photovoltaic arrays or panels comprising more than one photovoltaic module.

According to certain illustrative embodiments, the method of measuring the power delivery performance of a bifacial photovoltaic device may be used to collect I-V curve measurements for photovoltaic modules comprising a plurality of electrically connected photovoltaic cells that are arranged in a plane. According to other embodiments, the method of measuring the power delivery performance of a bifacial photovoltaic device may be used to collect I-V measurements for photovoltaic panels comprising more than one electrically connected photovoltaic modules that are arranged in a plane.

To collect I-V curve data from the photovoltaic device, the substantially non-reflective layer or surface is detachably or removably applied, affixed, connected to, or otherwise arranged on or near, at least a portion of the rear surface of the bifacial photovoltaic device. By way of illustration, and not limitation, the substantially non-reflective material layer or surface comprises an area that is coextensive with the rear of the photovoltaic device or portion of a photovoltaic device being measured. According to certain embodiments, the substantially non-reflective layer may comprise a single piece comprising an area co-extensive with an area on the rear surface of the photovoltaic device being measured. According to other embodiments, the substantially non-reflective layer may comprise more than one interlocked subunits that together when interlocked comprises the same or substantially the same area of the rear surface of the photovoltaic device being measured. The outer perimeter of the non-reflective layer applied to the rear surface of the bifacial photovoltaic device is substantially coextensive with the outer perimeter of the photovoltaic cell, module, or panel being measured.

According to certain embodiments, the non-reflective layer is positioned in detachable arrangement or contact with the rear surface of the bifacial photovoltaic device. According to certain embodiments, a gap or space may be present between the non-reflective layer and the rear surface of the bifacial photovoltaic device being measured, however, the I-V curve measurements are insensitive to any such gap or space.

The material used for the one or more layers of the substantially non-reflective surface may comprise a metal layer, a metal alloy layer, an infrared light absorbing layer, a visible light absorbing layer, ultra-violet light absorbing layer, and/or a layer the absorbs at least one of infrared light, visible light and ultra-violet light. The layer that absorbs the infrared light, visible light, and/or ultra-violet light may be selected from boards, cloths, fabrics, flocks, mats, papers, and sheets. The layer that absorbs at least one of infrared light, visible light, and/or ultra-violet may also be selected from liquid applied absorptive layers, such as, without limitation, coatings, films, and paints. According to certain illustrative embodiments, the liquid applied materials may be applied to an underlying substrate by brushing, rolling, or spraying, followed by drying to form a dried infrared light, visible light and/or ultra-violet light absorbing layer on the substrate. According to certain embodiments, the substantially non-reflective layer comprises an adhesive-backed fabric layer.

According to certain embodiments, the substantially non-reflective layer comprises a composite comprising at least one non-reflective, non-transmissive layer in the wavelength range of interest and at least one support layer that provides structural support, flexibility, and handleability. The term “wavelength of interest” refers to any wavelength of light that the bifacial photovoltaic cell can absorb and convert to useable electric energy. According to certain embodiments, the substantially non-reflective layer comprises a composite comprising one non-reflective, non-transmissive layer that absorbs light in the wavelength range of interest and one support layer that provides structural support, flexibility, and handleability. According to certain embodiments, the substantially non-reflective layer comprises a composite comprising one non-reflective, non-transmissive layer that absorbs infrared light and one support layer that provides structural support, flexibility, and handleability. According to certain embodiments, the substantially non-reflective layer comprises a composite comprising one non-reflective, non-transmissive layer that absorbs ultraviolet light and one support layer that provides structural support, flexibility, and handleability. According to certain embodiments, the substantially non-reflective layer comprises a composite comprising one non-reflective, non-transmissive layer that absorbs visible light and one support layer that provides structural support, flexibility, and handleability.

According to certain embodiments, the substantially non-reflective surface may comprise a substrate layer, a radiation barrier layer and an absorption layer. For example, and without limitation, the substantially non-reflective surface may comprise a multiple layer structure comprising a substrate, at least one metal layer surrounding the substrate, and at least one infrared light, visible light and/or ultra-violet light absorption layer surrounding the at least one metal layer. According to certain embodiments, the absorption layer and the radiation barrier layer may be combined into a layer to provide a non-reflective and non-transmissive layer that absorbs the light of the wavelength of interest, such infrared light, visible light, and/or ultraviolet light.

According to certain embodiments, the substantially non-reflective surface may comprise a substrate layer, a radiation barrier layer and an absorption layer. For example, and without limitation, the substantially non-reflective surface may comprise a multiple layer structure comprising a substrate, at least one aluminum layer surrounding the substrate, and at least one infrared light, visible light and/or ultra-violet light absorption layer surrounding the at least one aluminum layer. According to certain embodiments, the structure comprises a substrate layer and the absorption layer and the radiation barrier layer combined into a layer to provide a non-reflective and non-transmissive layer that absorbs the light of the wavelength of interest, such infrared light, visible light, and/or ultraviolet light and which surrounds the substrate layer.

According to certain embodiments, the substantially non-reflective surface may comprise a substrate layer, a radiation barrier layer and an absorption layer. For example, and without limitation, the substantially non-reflective surface may comprise a multiple layer structure comprising a substrate, at least one metal layer surrounding the substrate, and at least one infrared light, visible light and/or ultra-violet light flock sheet layer surrounding the at least one metal layer. According to certain embodiments, the flock sheet layer and metal layer may be combined into a layer to provide a non-reflective and non-transmissive layer that absorbs the light of the wavelength of interest, such infrared light, visible light, and/or ultraviolet light and which surrounds the substrate layer.

According to certain embodiments, the substantially non-reflective surface may comprise a substrate layer, a radiation barrier layer and an absorption layer. For example, and without limitation, the substantially non-reflective surface may comprise a multiple layer structure comprising a substrate, at least one aluminum foil layer surrounding the substrate, and at least one flock sheet layer that absorbs both visible light and/or ultra-violet light surrounding the at least one metal layer. The aluminum foil layer substantially or entirely prevents background irradiance to transmit through the at least one absorbing layer and into the rear surface of the bifacial photovoltaic module, while the flock sheet facing the rear of the photovoltaic module minimizes or prevents the reflection of exiting light back into the module. According to certain embodiments, the flock sheet layer and aluminum foil layer may be combined into a layer to provide a non-reflective and non-transmissive layer that absorbs the light of the wavelength of interest, such infrared light, visible light, and/or ultraviolet light and which surrounds the substrate layer.

The material used for the substantially non-reflective surface to be detachably applied on or to, or arranged near, the rear side of the bifacial photovoltaic device reduces the irradiance at the rear surface of the photovoltaic device as compared to the irradiance at the front surface of the bifacial photovoltaic device. According to certain illustrative embodiments, and not in limitation, the material used for the substantially non-reflective surface to be detachably applied on or to, or arranged near, to the rear side of the bifacial photovoltaic device reduces the irradiance at the rear surface of the photovoltaic device to less than 1%, or less than 0.9%, or less than 0.8%, or less than 0.75%, or less than 0.7%, or less than 0.6%, or less than 0.5%, or less than 0.4%, or less than 0.3%, or less than 0.25%, or less than 0.2% or less than 0.1% of the irradiance of the front surface of the photovoltaic device.

The material used for the substantially non-reflective surface to be detachably applied on or to, or arranged near, to the rear side of the bifacial photovoltaic device reduces the irradiance at the rear surface of the photovoltaic device may comprise a single layer of material or may comprise a multiple layer composite or stack.

According to certain illustrative embodiments, the non-reflective surface absorbs at least 75% of visible light, or at least 80% of visible light, or at least 85% of visible light, or at least 90% of visible light, or at least 95% of visible light, or at least 96% of visible light, or at least 97% of visible light, or at least 98% of visible light, or at least 99% of visible light, or at least 99.1% of visible light, or at least 99.2% of visible light, or at least 99.3% of visible light, or at least 99.4% of visible light, or at least 99.5% of visible light.

According to certain illustrative embodiments, the non-reflective surface absorbs at least 75% of ultra-violet light, or at least 80% of ultra-violet light, or at least 85% of ultra-violet light, or at least 90% of ultra-violet light, or at least 95% of ultra-violet light, or at least 96% of ultra-violet light, or at least 97% of ultra-violet light, or at least 98% of ultra-violet light, or at least 99% of ultra-violet light, or at least 99.1% of ultra-violet light, or at least 99.2% of ultra-violet light, or at least 99.3% of ultra-violet light, or at least 99.4% of ultra-violet light, or at least 99.5% of ultra-violet light.

According to certain illustrative embodiments, the non-reflective surface absorbs at least 95% of visible light and at least 95% of ultraviolet light, or at least 96% of visible light and at least 96% of ultraviolet light, or at least 97% of visible light and at least 97% of ultraviolet light, or at least 98% of visible light and at least 98% of ultraviolet light, or at least 99% of visible light and at least 99% of ultraviolet light, or at least 99.5% of visible light and at least 99.5% of ultraviolet light.

According to certain illustrative embodiments, the non-reflective surface absorbs at least 95% of visible light and at least 96% of ultraviolet light, or at least 95% of visible light and at least 96% of ultraviolet light, or at least 95% of visible light and at least 97% of ultraviolet light, or at least 95% of visible light and at least 98% of ultraviolet light, or at least 95% of visible light and at least 99% of ultraviolet light, or at least 95% of visible light and at least 99.5% of ultraviolet light.

According to certain illustrative embodiments, the non-reflective surface absorbs at least 96% of visible light and at least 95% of ultraviolet light, or at least 97% of visible light and at least 95% of ultraviolet light, or at least 98% of visible light and at least 95% of ultraviolet light, or at least 99% of visible light and at least 95% of ultraviolet light, or at least 99.5% of visible light and at least 95% of ultraviolet light.

According to certain illustrative embodiments, the non-reflective surface absorbs at least 75% of infrared light, or at least 80% of infrared light, or at least 85% of infrared light, or at least 90% of infrared light, or at least 95% of infrared light, or at least 96% of infrared light, or at least 97% of infrared light, or at least 98% of infrared light, or at least 99% of infrared light, or at least 99.1% of infrared light, or at least 99.2% of infrared light, or at least 99.3% of infrared light, or at least 99.4% of infrared light, or at least 99.5% of infrared light.

The method of measuring the power delivery performance of a bifacial photovoltaic device may comprise conducting a first measurement of the current and voltage characteristics of the bifacial photovoltaic device without the non-reflective layer or surface applied on or to, or arranged near, the rear surface of the bifacial photovoltaic device being measured, applying the non-reflective layer on or to the rear surface of the bifacial photovoltaic device or arranging the non-reflective layer or surface near the rear surface of the bifacial photovoltaic device, and conducting a second measurement of the current and voltage characteristics of the bifacial photovoltaic device after applying the non-reflective layer or surface to the rear side of the bifacial photovoltaic device. The results of the first measurement of the current and voltage characteristics are compared to the second measurement of the current and voltage characteristics to determine the power delivery performance of the bifacial photovoltaic device.

The method of measuring the power delivery performance of a field installed bifacial photovoltaic device may comprise conducting a measurement of the current and voltage characteristics of the bifacial photovoltaic device with the non-reflective layer on or near the rear surface of the bifacial photovoltaic device and comparing the results of the measurement of the current and voltage characteristics to the measurement of the current and voltage characteristics for the bifacial photovoltaic device under test provided by the manufacturer to determine the power delivery performance of the bifacial photovoltaic device.

The in situ method of measuring the power delivery performance of a field installed bifacial photovoltaic device may comprise conducting a measurement of the current and voltage characteristics of the field installed bifacial photovoltaic device with the non-reflective layer on or near the rear surface of the field installed bifacial photovoltaic device and comparing the results of the measurement of the current and voltage characteristics to the measurement of the current and voltage characteristics for the bifacial photovoltaic device under test provided by the manufacturer to determine the power delivery performance of the bifacial photovoltaic device.

The in situ method of measuring the power delivery performance of a field installed and operating bifacial photovoltaic device may comprise conducting a measurement of the current and voltage characteristics of the field installed and operating bifacial photovoltaic device with the non-reflective layer on or near the rear surface of the field installed bifacial photovoltaic device and comparing the results of the measurement of the current and voltage characteristics to the measurement of the current and voltage characteristics for the bifacial photovoltaic device under test provided by the manufacturer to determine the power delivery performance of the bifacial photovoltaic device.

The in situ method of measuring the power delivery performance of a field installed bifacial photovoltaic device may comprise conducting a first measurement of the current and voltage characteristics of the bifacial photovoltaic device without the non-reflective layer or surface applied on or to, or arranged near, the rear surface of the bifacial photovoltaic device being measured, applying the non-reflective layer on or to the rear surface of the bifacial photovoltaic device or arranging the non-reflective layer or surface near the rear surface of the bifacial photovoltaic device, and conducting a second measurement of the current and voltage characteristics of the bifacial photovoltaic device after applying the non-reflective layer or surface to the rear side of the bifacial photovoltaic device. The results of the first measurement of the current and voltage characteristics are compared to the second measurement of the current and voltage characteristics to determine the power delivery performance of the bifacial photovoltaic device under test.

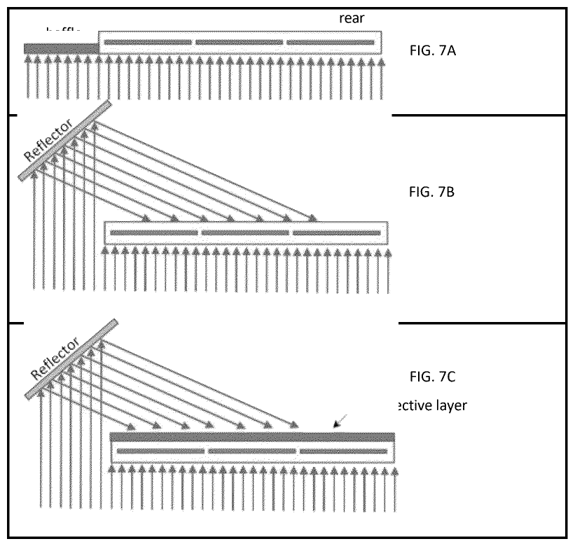

According to certain illustrative embodiments, a first measurement of the power delivery performance of a photovoltaic device is conducted by collecting current and voltage curve data at the factory with a set up as shown in FIG. 7A (simulation of a manufacturer's factory I-V curve setup). The factory I-V curve setup of FIG. 7A includes a baffle that is positioned to surround the outer perimeter of the photovoltaic panel being tested to prevent light from passing beyond the plane of the panel and with the rear surface of the panel being exposed. The current and voltage data is collected and an I-V curve for the photovoltaic panel is constructed based on the collected raw current and voltage data. A second measurement of the power delivery performance of a photovoltaic device is conducted after it is installed in the field by collecting current and voltage curve data with the presently disclosed Inventive Bifacial Field I-V Curve Setup. The Inventive Bifacial Field I-V Curve Setup includes a substantially non-reflective material layer or surface applied on or near a portion of the rear surface of the bifacial photovoltaic panel such that the portion of the rear surface of the panel is not exposed to light irradiation.

The substantially non-reflective material layer or surface applied to the rear surface of the photovoltaic panel substantially or entirely blocks rear surface irradiance that is directed to the rear surface of the panel. The results of the first measurement of the current and voltage characteristics are compared to the second measurement of the current and voltage characteristics to determine the power delivery performance of the bifacial photovoltaic device to determine whether the power delivery performance of the panel meets the manufacturer's power delivery performance rating. Current and voltage curves are constructed from the raw data collected for the first and second measurements. The current and voltage curves are used to calculate the electrical parameters STC Voc, STC Isc, STC Pmp, STC Vmp, and STC Imp for each of the first and second measurements. The ratio of the STC Voc, STC Isc, STC Pmp, STC Vmp, and STC Imp parameters derived from the current/voltage curve for the first measurement to the STC Voc, STC Isc, STC Pmp, STC Vmp, and STC Imp parameters derived from the current/voltage curve for the second measurement is calculated. A ratio above 100% indicates that the panel exhibits a power delivery performance that is increased relative to the performance as determined at the manufacturer's factory. A ratio below 100% indicates that the panel exhibits a power delivery performance that is decreased relative to the performance as determined at the manufacturer's factory.

Standard Test Conditions (STC) are used to determine the power output of the photovoltaic panels. Under Standard Test Conditions, photovoltaic panels are tested at 25° C. (77° F.) and exposed to 1,000 watts per square meter (1 kW/m²) of solar irradiance when the air mass is at 1.5. The parameter STC Voc means the open-circuit voltage (Voc) measured under standard test conditions. The open circuit voltage is the maximum voltage that the photovoltaic panel can produce with no load on it. The parameter STC Isc means the short-circuit current (Isc) measured under standard test conditions. Short-circuit current is the current that flows out of the photovoltaic panel when the positive and negative leads are shorted together. The parameter STC Vmp means the voltage at maximum power (Vmp) measured at standard test conditions. The voltage at maximum power is the voltage when the power output is the greatest. The parameter STC Imp means the current at maximum power (Imp) as measured at standard test conditions. The Imp is the current (amps) when the power output is the greatest. The parameter STC Pmp, also referred to as the Maximum Power Point (Pmax), means the maximum power the photovoltaic panel can produce at standard test conditions.

To ensure that the conditions are substantially the same for the first and second measurements, the time lapse between conducting the first measurement of the current and voltage characteristics of the bifacial photovoltaic device and conducting the second measurement of the current and voltage characteristics of the bifacial photovoltaic device should be about 10 minutes or less, about 5 minutes or less, about 4 minutes or less, about 3 minutes or less, about 2 minutes or less or about 1 minute or less. According to certain embodiments, the time lapse between conducting the first measurement of the current and voltage characteristics of the bifacial photovoltaic device and conducting the second measurement of the current and voltage characteristics of the bifacial photovoltaic device is 5 minutes or less.

According to certain embodiments, the in-situ method comprises positioning at least one temperature sensor (ie, thermocouple) to the rear side of the photovoltaic module under test to collect temperature measurements of the panel during the testing. The temperature sensor may be positioned on the rear side of the panel by any means sufficient for the temporary placement of the temperature sensor on the rear surface of the panel for the duration of the testing and which does not interfere with the irradiance measurements. For example, and without limitation, the temperature sensor may be temporarily positioned to the rear side of the panel with an optically transparent adhesive tape. According to certain embodiments, the dimensions of the temperature sensor may be about one-third of the width of the photovoltaic module under test and about one-fourth of the length from a corner of the photovoltaic module. At least one temperature sensor is positioned a bifacial photovoltaic device without the non-reflective surface applied thereto, which is a bifacial photovoltaic module that is the same model module as the module under test and is mounted in the same or similar condition. The temperature of the module under test is determined by collecting temperature measurements and comparing the Voc of the bifacial photovoltaic device with the non-reflective surface applied thereto with the Voc of the bifacial photovoltaic device without the non-reflective surface applied thereto.

Unknown rear side irradiance present during a bifacial I-V sweep of a photovoltaic module, and unknown temperature shift induced by the presence of the substantially non-reflective layer or surface applied to the rear side of the photovoltaic module under test during a frontside only I-V sweep, may be calculated from intermediate STC translations of these measured I-V curves. The translation method utilizes two I-V sweeps where the first I-V sweep is taken of the bifacial photovoltaic module without the substantially non-reflective layer or surface applied on or near the rear side of the module (this is referred to as the bifacial I-V sweep below) and the second I-V sweep is taken with the substantially non-reflective layer or surface applied to the rear side of the module (this is referred to as the frontside only I-V sweep below).

Equation 1, below, shows the calculation used to determine the unknown rear side irradiance, E_{R,B}, present during the bifacial IV sweep:

$${E}_{R , B} = {E}_{F , B} \{ \frac{{I}_{SC , B , iSTC}}{{I}_{SC , FO , iSTC}} - 1 \} \qquad Equation 1$$

where:
E_{R,B}=effective irradiance on the backside of the module under test during its bifacial IV curve measurement;
E_{F,B}=effective irradiance on the frontside of the module under test during its bifacial IV curve measurement;
I_{SC,B,ISTC}=STC value of I_{SC} resulting from the intermediate translation of the measured bifacial IV curve (i.e., rear side irradiance is neglected during the STC translation);
I_{SC,FO,iSTC}=STC value of I_{SC} resulting from the intermediate translation of the measured frontside-only IV curve (i.e., the perturbance of module temperature due to the application of the substantially non-reflective layer or surface is neglected during the STC translation).

Equation 2, below, shows the calculation used to determine the change in temperature, ΔT_{Blackout}, induced by the presence of the substantially non-reflective layer or surface on the rear side of the module under test during the frontside-only IV sweep:

$$Δ {T}_{Blackout} = \frac{1}{β} \{ \frac{{V}_{OC , FO , iSTC} - {V}_{OC , B , iSTC}}{{V}_{OC , B , STC}} \} \qquad Equation 2$$

where:
ΔT_{Blackout}=change in temperature at the time of the frontside-only IV sweep that is caused by the presence of substantially non-reflective layer or surface on the rear side of the module;
β=open circuit voltage coefficient of temperature (%/° C.);
V_{OC,FO,iSTC}=STC value of VOC resulting from the intermediate translation of the measured frontside-only IV curve assuming the temperature of the instrumented reference module is representative of the module under test at the time of the frontside-only IV sweep (i.e., the change in temperature induced by the substantially non-reflective layer or surface is neglected in the STC translation);
V_{OC,B,iSTC}=STC value of Voc resulting from the intermediate translation of the measured bifacial IV curve.

The underestimation of irradiance present during the bifacial IV sweep can be corrected by adding the calculated value of rear side irradiance, E_{R,B}, to the measured irradiance. Similarly, the underestimation of module temperature recorded during the frontside-only IV sweep is corrected by adding ΔT_{Blackout} to the measured temperature. Repeating the STC translation of the measured IV curves with these updated irradiance and temperature values yields the true STC performance of the module under test.

The in-situ method comprises positioning at least one irradiance sensor in the plane of array of the photovoltaic module under test. At least one irradiance sensor is positioned on an adjacent module of the photovoltaic panel under test. According to certain embodiments, and without limitation, the irradiance sensor is positioned on an adjacent photovoltaic module along an imaginary line connecting the center of the bottom edge of the module to the top edge of the module. The irradiance sensor should be positioned at a location such that the sensor does not interfere or block irradiance of the module under test but that the irradiance sensor remains in the same plane of array of the module under test. By way of illustration, but not limitation, the irradiance sensor in positioned in the same plane of array as the module under test along an imaginary line connecting the bottom edge to the top edge of the module adjacent the module under test and offset from the bottom edge of the adjacent module.

Following the placement of the temperature and irradiance sensors to the photovoltaic panel, an I-V curve tracer is electrically connected to the electrical leads of the photovoltaic module under test. The first measurement of the current and voltage characteristics of the bifacial photovoltaic module under test is conducted without the substantially non-reflective material layer or surface applied to the rear side of the module under test. The I-V curve tracer then sweeps an electrical load connected to the photovoltaic module under test and measures both the current and voltage at multiple points during the sweep. The raw I-V data collected during the sweep is used to construct an I-V curve for the photovoltaic module under test. The first measurement of the bifacial photovoltaic module under test provides the Voc for the module while the module remains in thermal equilibrium with its surroundings.

Following completion of the first measurement of the bifacial module under test, the substantially non-reflective material layer or surface is applied to a portion of the rear side of the module under test and a second measurement of the current and voltage characteristics are conducted with the I-V tracer. The temperature and irradiance sensors placed on the module under test prior to the first measurement of the current and voltage characteristics remain in the same position for the second measurement. According to certain embodiments, the elapsed time between the first and second measurements is about 5 minutes. The measured Voc is used to calculate the temperature of the module under test, T_blackout during the I-V sweep of the second measurement, using the following equation: T_blackout=(T_bifacial+(Voc_blackout−Voc_bifacial)/β wherein β is the open-circuit temperature coefficient. The temperature of the module under test is recorded during the I-V curve sweep. The substantially non-reflective material layer or surface applied to the rear side of the module under test pushes the module under test far from equilibrium and the Voc-based temperature determination is a more accurate method of determining the temperature of the module under test during the I-V curve sweep.

The raw I-V data collected by the I-V curve sweep of the module under test are collected and stored by the I-V tracer device. The collected raw I-V data is mathematically corrected to standard test conditions (STC) by correcting for temperature, irradiance, incidence angle, and spectral responses of the module under test and the irradiance sensor. The stored raw data for temperature, irradiance, and the I-V data collected at multiple points during the I-V sweeps of the module under test are run through an algorithm to provide the final power delivery performance results for the photovoltaic module under test.

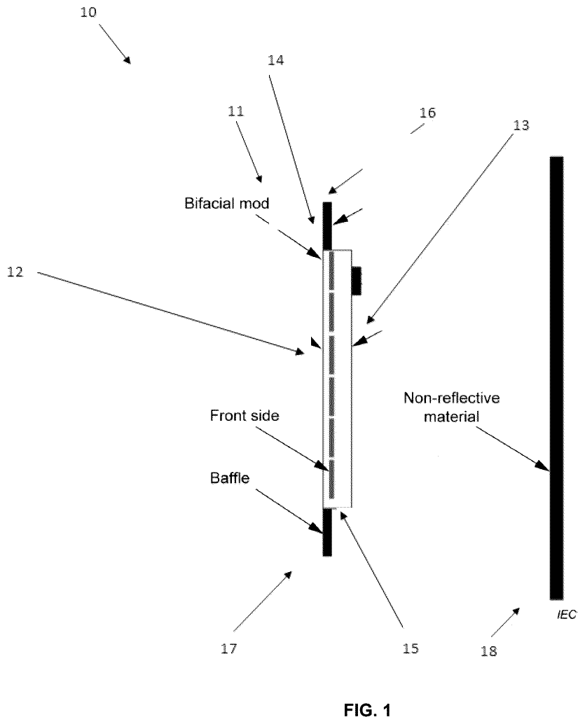

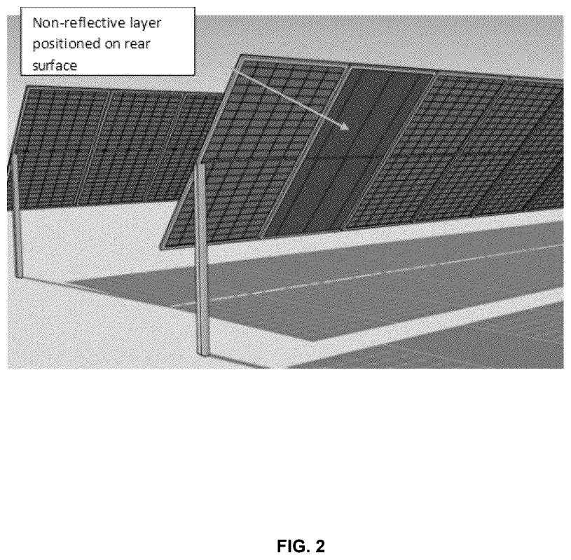

The IEC's photovoltaic panel test setup 10 is depicted in FIG. 1. The test setup 10 includes a bifacial photovoltaic array 11 having a front side 12 and a rear side 13 and marginal edges 14, 15. Baffles 16, 17 are positioned along the marginal edges 14, 15. Baffles 16, 17 are used to prevent passage of light from the front side 12 of the array 11 beyond the plane of the array 11 and a non-reflective material 18 positioned behind the photovoltaic array 11 to reduce reflection of light onto the rear side 13 of the array 11. The test setup 10 is designed to suppress irradiance to 3 W/m² on the non-exposed rear side 13 of the bifacial photovoltaic array 11 before measuring the IV curve of the front side 12 of the array 11.

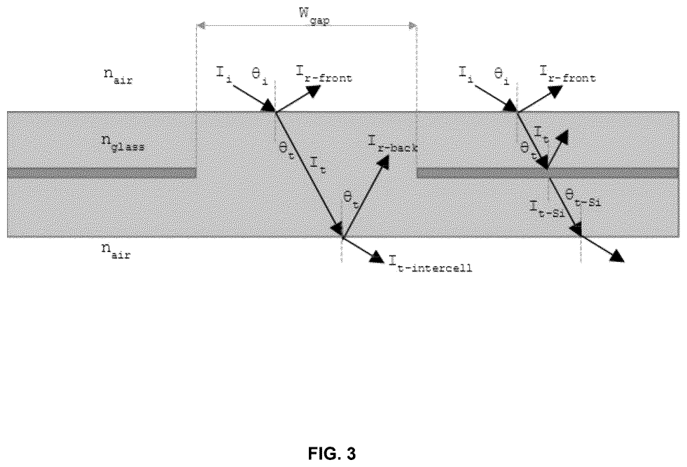

To determine the maximum permissible reflectance of the substantially non-reflective surface, the maximum transmission of front side light through the photovoltaic module must first be calculated. Using this value, an appropriate upper specification limit for total hemispherical reflectivity of the substantially non-reflective surface material over the relevant portion of the spectrum can be calculated. There are two sources of light transmission through the photovoltaic module that must be considered, light passing through the open areas outside of the photovoltaic cell area (e.g., gaps between photovoltaic cells) and the light transmitted directly though semiconductor wafers. These sources of light transmission in turn are used to establish the fraction of frontside irradiance that is expected to exit the rear surface of the photovoltaic module. Without being bound to any particular theory, it is believed that a bifacial module without white mesh between cells and with thin silicon wafers will allow the highest fraction of light to escape. A simplified optical model may be used with Fresnel's equations to quantify the light transmission through the photovoltaic module as shown in FIG. 3.

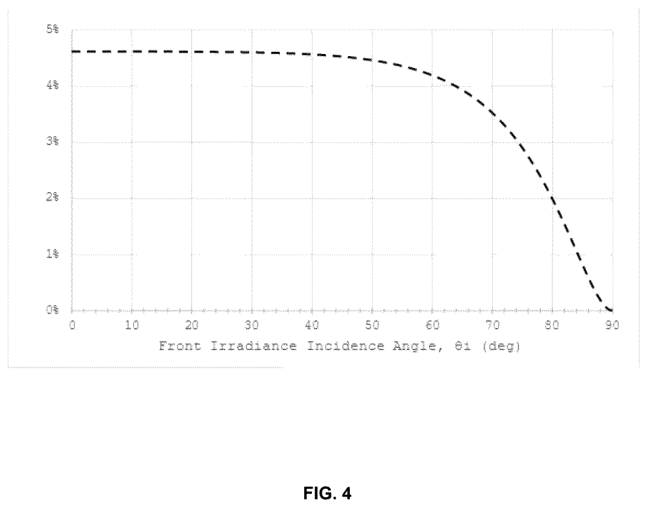

According to certain embodiments, bifacial photovoltaic modules have approximately 5% of total module area that is not occupied by photovoltaic cells. In glass/glass or glass/clear-backsheet modules without white mesh between individual photovoltaic cells, all light passing through the intercell gaps on the module has the possibility of being transmitted through the entire module and exiting the rear surface. The total fraction of incident light intensity passing through the intercell gaps and out of the back surface of the photovoltaic module is calculated as a function of incidence angle as shown in FIG. 4. As shown in FIG. 4, the highest fraction of front side irradiance escaping the photovoltaic module through the gaps between individual photovoltaic cells occurs at normal incidence. A maximum of 4.6% of the incident light escapes the module through the intercell gaps. Assuming an 85% bifaciality of the module, the expected current boost if all intercell light were reflected into the solar cells by the blackout material is 3.91%. In photovoltaic module designs having white mesh between individual photovoltaic cells, a large portion of intercell light is redirected back into the module rather than exiting the module. Therefore, the requirements on the substantially non-reflective surface material are significantly relaxed for bifacial modules with white mesh between cells. This is because the white mesh redirects intercell light back into the photovoltaic module, the intensity of light reaching the substantially non-reflective surface material is reduced and a higher blackout reflectivity can be tolerated.

Light transmission through the silicon cell is the second source of light that the substantially non-reflective surface material must absorb. The alterations to the incident spectrum by transmission through the silicon wafer can be calculated using the absorption coefficient of silicon vs wavelength assuming no light trapping to increase the optical pathlength. The intensity of light as it reaches the backside of the photovoltaic cell must pass through several interfaces on the transmission through the module, to the substantially non-reflective surface material, and then back into the module. The fraction of light lost due to reflection at each of these interfaces is calculated using Fresnel's equation for reflectance at normal incidence R=(n1−n2)\hat{ }2/(n1+n2)\hat{ }2. Once the spectrum of light re-entering the silicon cell is determined, the current generated by the spectrum is calculated using the spectral response curve of the silicon solar cell with an assumed bifaciality of 85%. FIG. 5 shows the irradiance spectrum initially incident upon the module and the spectrum of the light re-entering the cell after being reflected from the blackout material (assuming 100% reflectivity of the blackout material). The maximum expected current boost due to reflection of light transmitted through the silicon wafer back into the module from the blackout material is 3.62%. It is known that actual light transmission through bifacial photovoltaic cells is less than 50% of the above estimated value due to light trapping techniques used to increase the optical pathlength in the wafer from multiple internal reflections. Taking this into account, the impact of reflecting light transmitted through the silicon wafers back into the module is revised downward to 50% of 3.62%, or to 1.81%.

The impact of intercell light transmission (+3.91%) and light transmission through the silicon wafer (+1.81%) provides a maximum combined measurement error of +5.72% if a 100% reflective material were selected for covering the rear surface of the photovoltaic module during front side in situ I-V curve measurement in the field. According to certain embodiments, the contribution of backside irradiance, Eᵣₑₐᵣ, on module output should be 0.3% or less compared to the front side irradiance when measuring front side I-V characteristics. Therefore, the total reflectance of the substantially non-reflective material, R_{black}, over the portion of the relevant spectrum (˜300 nm to 1200 nm for c-Si modules) can be determined from the following inequality assuming 5.72% of the frontside irradiance is reaching the surface of the substantially non-reflective material:

$$5.72 \% \times {R}_{black} \leq 0.3 \% \to {R}_{black} \leq 5.2 \% \qquad ( Eqn1 )$$

According to certain embodiments, any substantially non-reflective material with a weighted total Reflectance of less than 5.2% should be sufficient to meet IEC 60902-1-2:2019 requirement that backside irradiance be 0.3% or less.

According to other embodiments, the non-reflective layer or surface may reduce the irradiance at the rear surface of the photovoltaic device to less than 1%, or less than 0.9%, or less than 0.8%, or less than 0.75%, or less than 0.7%, or less than 0.6%, or less than 0.5%, or less than 0.4%, of the irradiance of the front surface of the photovoltaic device.

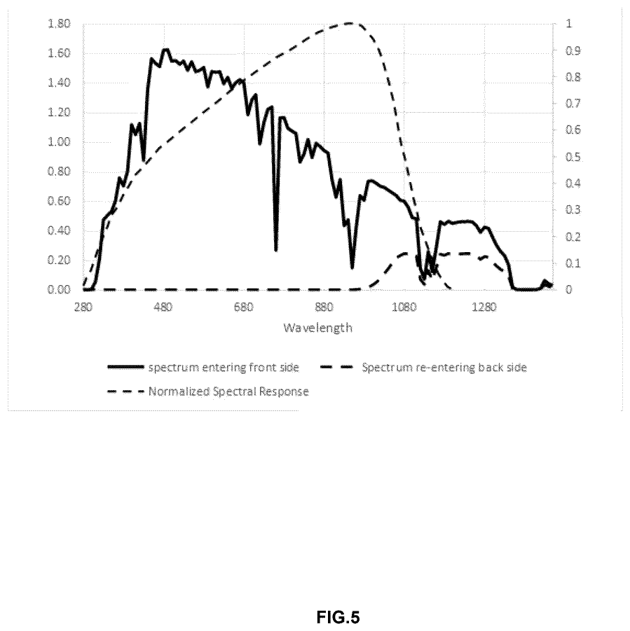

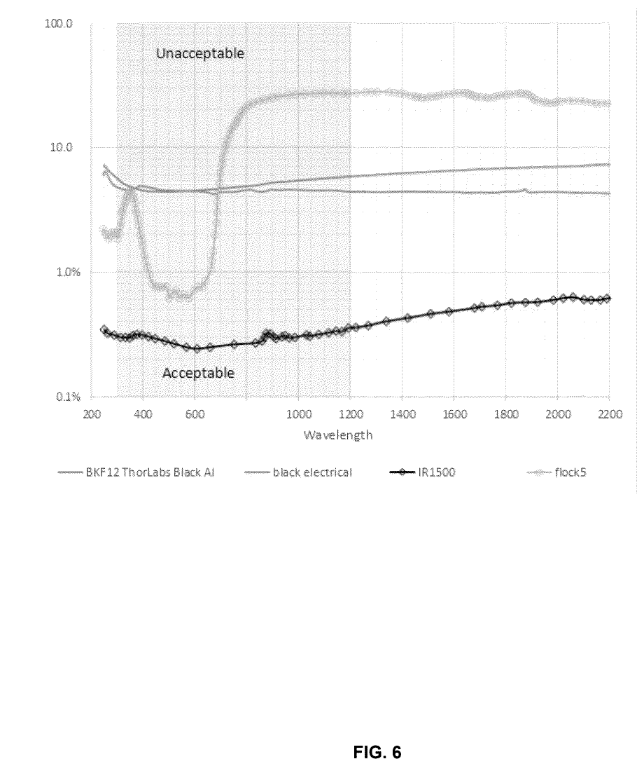

The total hemispherical spectral reflectance of several potential substantially non-reflective materials is shown in FIG. 6. As shown in FIG. 6, reflectance curves confined to the green shaded region show acceptably low reflectance for use as substantially non-reflective materials. Any curve with a portion of its reflectivity curve in the red shaded region has unacceptably high reflectance for use as substantially non-reflective materials. According to one embodiment, IR1500 flock sheet shows excellent performance over the entirety of the relevant spectral range and is specifically designed to have low IR reflectance. According to other embodiments, black electrical tape is marginally acceptable, although it does not perform as well as the IR1500 flock sheet, and the electrical tape compositions may vary as it is not a material engineered for its optical qualities. The ThorLabs black aluminum foil with part number BKF12 is commercially available as an optical material with controlled properties, however, the curve for BKF12 is slightly beyond the cutoff of 5.2% due to elevated reflectivity in the IR portion of the spectrum.

### EXAMPLES

The disclosure is further described with reference to the following non-limiting examples. The following examples are given solely for the purpose of illustration and are not to be construed as limitations of the present invention, as many variations of the invention are possible without departing from the spirit and scope of the present disclosure.

The testing apparatus and method of the present disclosure was compared to known factory testing and field testing methods. The testing setups are shown in FIGS. 7A-7C.

The schematic test setup shown in FIG. 7A is a laboratory test setup to simulate measuring the I-V curves in the photovoltaic device in the manufacturer's factory prior to sending the photovoltaic system into the stream of commerce. The test setup of FIG. 7A utilizes baffles to block light from passing beyond the front side of the photovoltaic module and the rear side of the photovoltaic module is exposed. The schematic test set up shown in FIG. 7A is referred to herein as the “Factory I-V Curve Setup”. The I-V curve using the Factory I-V Curve Setup was measured in compliance with IEC 60904-1-2 with rear irradiance not exceeding 3 W/m².

The schematic test setup shown in FIG. 7B is a laboratory test setup for measuring the I-V curves in the photovoltaic device that has been installed in the field without a non-reflective layer on the rea surface of the panel under test. The test setup of FIG. 7B utilizes a reflector positioned behind the photovoltaic module and the rear side of the photovoltaic module is exposed. The schematic test set up shown in FIG. 7B is referred to herein as the “Bifacial Field I-V Curve Setup”. The I-V curve collected by using the Bifacial Field I-V Curve Setup has the rear side reflector in place that directs a substantial portion of the irradiance onto the rear surface of the photovoltaic module. The Bifacial Field I-V Curve Setup emulates the I-V curve measurements taken in the field from a photovoltaic module with a known front side irradiance and an unknown and non-uniform contribution to output from the rear surface irradiance.

The schematic test setup shown in FIG. 7C represents a laboratory set up approximating the presently disclosed testing apparatus and system for use in the presently disclosed method for measuring the I-V curves in the photovoltaic device that has been installed in the field. For purposes of this set of tests, the laboratory test setup of FIG. 7C utilizes a reflector positioned behind the photovoltaic module and the rear side of the photovoltaic module as shown in FIG. 7B for the Bifacial Field I-V Curve Setup. According to the inventive testing apparatus shown in FIG. 7C, the rear side of the photovoltaic module is not exposed, but the substantially non-reflective layer material applied to the rear side of the module. The test set up shown in FIG. 7C is referred to herein as the “Bifacial Field I-V Curve Setup with Non-reflective Layer”. It should be noted that according to the presently disclosed method and system, the separate reflector shown in FIG. 7C positioned behind and at a distance from the photovoltaic panel (and directly light toward the rear side of the module under test) is not included as a feature or limitation of the present method, apparatus, or system. An I-V curve was collected in accordance with the presently disclosed Inventive I-V Curve Setup under the same conditions as the I-V curve collected using the Bifacial Field I-V Curve Setup shown in FIG. 7B, except the substantially non-reflective layer material applied to the rear side of the module blocks the rear surface irradiance directed to the rear side of the module by the reflector.

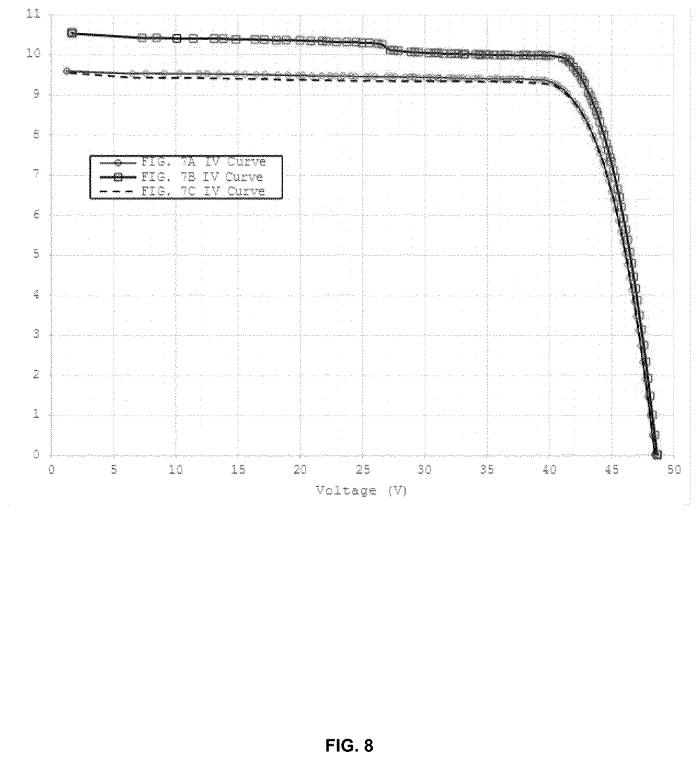

FIG. 8 shows the I-V curves collected using the laboratory test setups shown in FIGS. 7A, 7B, and 7C. The results of the I-V-collection for the Factory I-V Curve Setup and the Bifacial Field I-V Curve Setup with Non-reflective Layer should be the same or substantially the same. As can be seen by the results presented in the graph of FIG. 8, the use of the substantially non-reflective layer or surface material applied to the rear side of the photovoltaic module blocks all rear surface irradiance and results in an I-V curve that is virtually identical to the I-V curve collected using Factory I-V Curve Setup. Table 1 below shows the key electrical parameters for the I-V curves collected using the laboratory test setups shown in FIGS. 7A, 7B, and 7C

TABLE 1

| | STC Voc | STC Isc | STC Pmp | STC Vmp | STC Imp |
|---|---|---|---|---|---|
| Test Setup | (V) | (A) | (W) | (V) | (A) |
| Factory I-V Curve Setup | 48.53 | 9.57 | 374.81 | 41.01 | 9.14 |
| Bifacial Field I-V Curve Setup | 48.67 | 10.55 | 409.09 | 41.57 | 9.84 |
| Bifacial Field I-V Curve Setup with Non- | 48.51 | 9.54 | 373.88 | 40.93 | 9.14 |
| reflective Layer | | | | | |

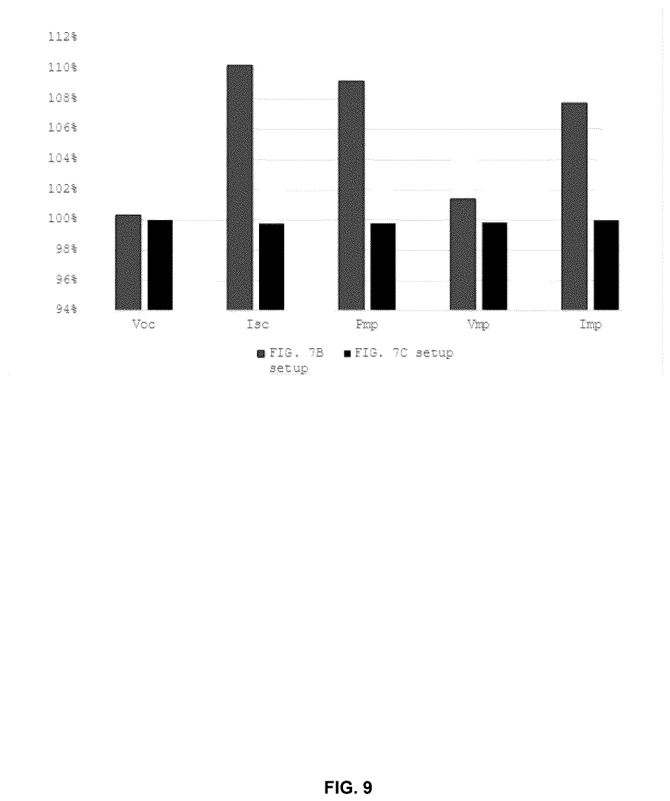

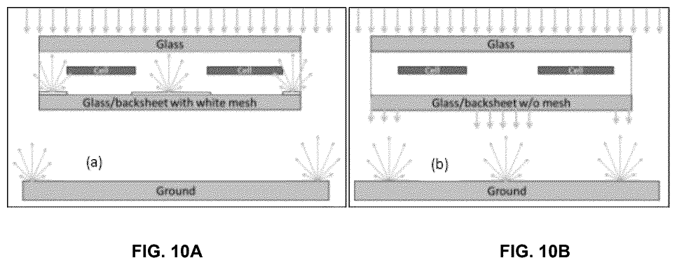

FIG. 9 shows the ratio of electrical parameters of Bifacial Field I-V Curve Setup and Bifacial Field I-V Curve Setup with Non-reflective Layer test conditions are shown relative to the electrical parameters of the Factory I-V Curve Setup. Values above 100% indicate an increase relative to the factory test conditions; values below 100% indicate a decrease relative to factory test conditions. FIG. 9 shows that the Bifacial Field I-V Curve Setup conditions results in substantial increases in Isc (+10.2%), Pmp (+9.1%), and Imp (+7.7%) due to additional rear surface irradiance during the I-V sweep. Assuming a bifaciality of 75%-85% for maximum power, the effective rear surface irradiance during the bifacial I-V sweep using the Bifacial Field I-V Curve Setup is 121-108 W·m⁻².

The percentage change (Δ) in the I-V curve measurements collected using the Bifacial Field I-V Curve Setup and the Bifacial Field I-V Curve Setup with Non-reflective Layer in comparison to the I-V curve collected using the Factory I-V Curve Setup are show in Table 2 below. The results of Table 2 show the use of a non-reflector layer o the rear surface of the bifacial photovoltaic panel under test was able to block the rear side irradiance and reproduce the maximum power measurement taken in accordance with the Factory I-V Curve Setup test condition to within 0.25%.

TABLE 2

| Test Setup | Δ Voc | Δ Isc | Δ Pmp | Δ Vmp | Δ Imp |
|---|---|---|---|---|---|
| Bifacial Field I-V Curve Setup | +0.30% | +10.20% | +9.15% | +1.35% | +7.69% |
| Bifacial Field I-V Curve Setup with Non- | −0.04% | −0.26% | −0.25% | −0.20% | −0.05% |
| reflective Layer | | | | | |

The power delivery performance of a bifacial photovoltaic module installed in the field and operating under normal operating conditions was measured in accordance with the disclosed measurement method. The measurements includes measuring the in-situ power delivery performance of a bifacial photovoltaic device installed in the field and operating with an open rear side or surface without the substantially non-reflective layer applied to the rear side of the module under test, measuring the in-situ power delivery performance of a bifacial photovoltaic device installed in the field and operating with the substantially non-reflective layer applied to the rear side of the module under test, and comparing the measured power delivery performance of the photovoltaic device with the open rear side with the measured power delivery performance of the photovoltaic device with the substantially non-reflective layer applied to the rear side of the module under test to determine the bifacial contribution to the power delivery output or performance of the module. The details photovoltaic module tested are as follows:
Module/Panel Type: LONGi LR6-78HBD-405M
Cell Type: ½ cell 5 busbar mono-Si
Cells/Module: 78-cells in series
String Length: 25 module/string
Mounting System: ATI Duratrack HZ V3
Inverter Topology: SunGrow Module SG2500U
Latitude, Lingitude: 31.22° N, 102.19° W
System Age: about 3.1 years at time of testing

For purposes of the present example, the phrase “Bifacial IV Curve” refers to the current-voltage response of a bifacial photovoltaic module with both front and rear surfaces exposed as intended during normal operation in the system design. The rear side irradiance entering the module during a bifacial I-V sweep is difficult if not impossible to measure directly. Only the front side irradiance and module temperature are known quantities during a bifacial I-V curve measurement.

For purposes of this example, the phrase “Frontside-Only IV Curve” refers to the I-V curve of a module with no rear side irradiance. Measurement of a frontside-only I-V curve from a bifacial module in the field is accomplished by blacking out the rear side of the photovoltaic module with the substantially non-reflective layer or surface disclosed herein that neither transmit nor reflect the relevant portion of the solar spectrum. Under these conditions, there is no backside or rear side contribution to the measured module power output, therefore the measured frontside irradiance is an accurate measure of total irradiance. The application of the substantially non-reflective layer or surface to the rear side of the module disrupts the thermal equilibrium and thermal uniformity of the module which makes direct measurement of the module temperature impractical.

For purposes of this example, the phrase “STC IV Curve” refers to the current-voltage response of a photovoltaic module translated to Standard Test Conditions (STC). STC conditions stipulate that only frontside irradiance is present with an Air Mass 1.5 spectrum at 1000 W/m² and normal incidence while maintaining a cell temperature of 25° C. The STC results of monofacial and bifacial photovoltaic modules are both reported without contributions from the rear surface.

For purposes of this example, the phrase “Instrumented Reference Module” refers to a photovoltaic module with a frontside Plane of Array (POA) irradiance sensor and a surface thermocouple mounted to the backside of the photovoltaic module. The Instrumented Reference Module is kept at its open-circuit voltage (Voc) and remains in thermal equilibrium with its surroundings and is identical to the photovoltaic module under test in all aspects, including make, model, age, mounting system, azimuth, tilt, and proximity to the module under test. During testing, the frontside irradiance and temperature readings from the Instrumented Reference Module are recorded as the frontside irradiance and temperature for the module under test. The Instrumented Reference Module is used because placing the irradiance sensor and thermocouple on the module under test would distort the measured I-V curves.

For purposes of this example, the phrase ‘Intermediate STC Translation’ (ISTC), refers to an STC translation of an as-measured I-V curve to STC conditions using as-measured irradiance and/or temperatures with known systematic bias. For example, translating a bifacial I-V curve to STC neglecting rear side irradiance will overestimate the STC power by the exact amount contributed from the rear side irradiance of the module at the time of measurement. Similarly, translating a frontside-only I-V curve measured from a blacked-out bifacial module using the Instrumented Reference Module's temperature will underestimate STC power because the blacked-out module temperature is higher than the Instrumented Reference Module in most cases. Fortunately, comparison of the intermediate STC (ISTC) translations of the bifacial and frontside-only I-V curves for the same module provides the information needed to eliminate the irradiance and temperature errors inherent in these measurements.

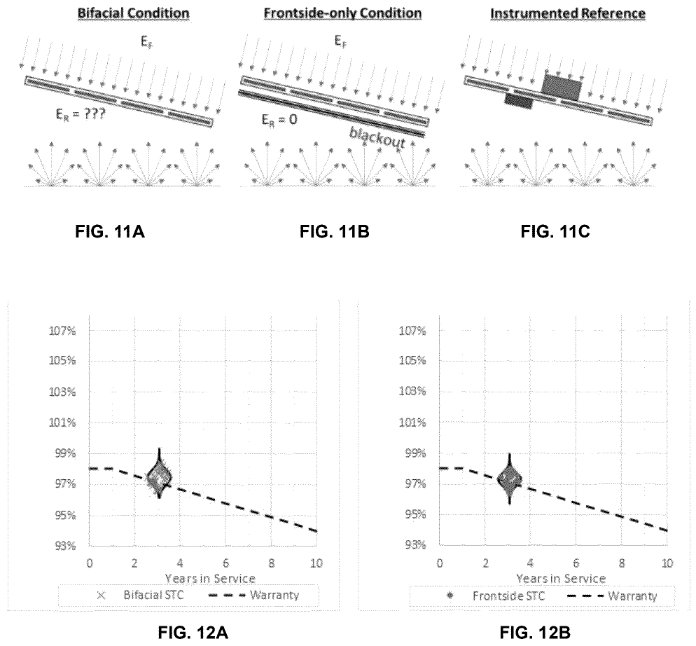

Twenty-three (23) photovoltaic modules were tested. The bifacial and frontside-only I-V curves were measured from the same module within 3 minutes of one another on a clear sky day to ensure the module's position, frontside irradiance, spectrum, and position of the sun are unchanged between the bifacial and frontside-only I-V curve measurements. The irradiance and temperature recorded for each I-V sweep originate from the Instrumented Reference Module equipped with a front facing irradiance sensor and backside thermocouple mounted thereto. Schematic representations of the module under test (MUT) and Instrumented Reference Module (IRM) are shown in FIGS. 11A-11C.

During the bifacial I-V sweep, the module temperature, T_{M,B}, is known, However, the total irradiance entering the module under test is unknow due to difficulties in accurately measuring the highly nonuniform and non-directional irradiance, E_{R,B}, on the rear surface of the module. During the frontside-only I-V sweep, the rear side irradiance is forced to zero via the substantially non-reflective layer applied to the rear of the module. Therefore, the total irradiance is known. The application of the substantially non-reflective layer disrupts the thermal equilibrium and thermal uniformity of the module and therefore the module temperature, T_{M,FO}, is unknown for the frontside-only I-V sweep. The unknown rear side irradiance present during the bifacial I-V sweep, and the unknown temperature shift induced by the substantially non-reflective layer applied during the frontside-only I-V sweep can be calculated from intermediate STC translations of these as measured I-V curves in accordance with Equations 1 and 2 described above. Table 3 below shows the results of applying Equation 1 described herein to determine the rear side irradiance present during each Bifacial I-V Curve measurements and Equation 2 to determine the temperature change induced by the application of the substantially non-reflective layer on the rear side of the modules under test during each Frontside-only I-V Curve measurements.

TABLE 3

| Module Tested | E_{R,B} (W/m²) | ΔT_{Blackout}(K) |
|---|---|---|
| Module 1 | 98.62 | 6.18 |
| Module 2 | 81.53 | 2.90 |
| Module 3 | 70.96 | 3.44 |
| Module 4 | 68.63 | 2.35 |
| Module 5 | 68.36 | 2.70 |
| Module 6 | 63.77 | 1.91 |
| Module 7 | 60.59 | 3.74 |
| Module 8 | 63.20 | 4.10 |
| Module 9 | 59.90 | 3.65 |
| Module 10 | 61.71 | 4.21 |
| Module 11 | 58.05 | 3.86 |
| Module 12 | 55.46 | 2.81 |
| Module 13 | 60.13 | 3.73 |
| Module 14 | 55.98 | 3.37 |
| Module 15 | 58.04 | 3.86 |
| Module 16 | 56.61 | 3.80 |
| Module 17 | 59.63 | 3.34 |
| Module 18 | 57.06 | 3.37 |
| Module 19 | 61.09 | 3.76 |
| Module 20 | 61.69 | 3.43 |
| Module 21 | 58.35 | 3.69 |
| Module 22 | 60.30 | 3.32 |
| Module 23 | 56.83 | 4.11 |

Table 4 below shows the manufacturer's nameplate rating and the STC I-V parameters for all photovoltaic module tested in this example.

TABLE 4

| | | Bifacial STC/Frontside-only STC | | | | |
|---|---|---|---|---|---|---|
| Module | Rating (W) | Isc (A) | Voc (V) | Imp (A) | Vmp (V) | Pmp (W) |
| 1 | 405 | 9.77/9.66 | 52.5/52.6 | 9.02/9.12 | 44/43.3 | 396.4/394.6 |
| 2 | 405 | 9.71/9.72 | 52.4/52.6 | 9.15/9.15 | 43.4/43.2 | 397.4/394.7 |
| 3 | 405 | 9.62/9.6 | 52.3/52.5 | 9.04/9.05 | 43.3/43.3 | 391.4/391.6 |
| 4 | 405 | 9.58/9.65 | 52.3/52.4 | 9.07/9 | 43.2/43.4 | 391.5/390.4 |
| 5 | 405 | 9.69/9.69 | 52.4/52.5 | 9.11/9.1 | 43.2/43.2 | 393.6/393.2 |
| 6 | 405 | 9.64/9.7 | 52.4/52.6 | 9.08/9.01 | 43.3/43.4 | 392.7/391.5 |
| 7 | 405 | 9.65/9.6 | 52.6/52.7 | 9.05/9.07 | 43.6/43.3 | 394.3/392.7 |
| 8 | 405 | 9.62/9.58 | 52.6/52.7 | 9.03/9.05 | 43.5/43.4 | 392.3/392.7 |
| 9 | 405 | 9.65/9.6 | 52.6/52.7 | 9.04/9.06 | 43.5/43.4 | 393.6/393.5 |
| 10 | 405 | 9.62/9.58 | 52.5/52.6 | 9.04/9.05 | 43.3/43.3 | 391.7/392.3 |
| 11 | 405 | 9.66/9.6 | 52.7/52.8 | 9.05/9.1 | 43.7/43.4 | 395.8/395.2 |
| 12 | 405 | 9.69/9.65 | 52.6/52.7 | 9.1/9.12 | 43.6/43.4 | 396.4/395.9 |
| 13 | 405 | 9.63/9.6 | 52.5/52.6 | 9.06/9.08 | 43.6/43.4 | 394.9/393.6 |
| 14 | 405 | 9.65/9.62 | 52.5/52.6 | 9.05/9.07 | 43.5/43.3 | 393.4/392.9 |
| 15 | 405 | 9.69/9.63 | 52.5/52.7 | 9.01/9.06 | 43.7/43.4 | 393.6/393.5 |
| 16 | 405 | 9.67/9.63 | 52.6/52.8 | 9.05/9.08 | 43.7/43.6 | 395.7/395.9 |
| 17 | 405 | 9.7/9.64 | 52.6/52.7 | 9.06/9.1 | 43.5/43.4 | 394.2/395 |
| 18 | 405 | 9.73/9.68 | 52.6/52.8 | 9.08/9.11 | 43.8/43.5 | 397.5/396.5 |
| 19 | 405 | 9.65/9.64 | 52.7/53 | 9.05/9.09 | 43.6/43.6 | 395/396.5 |
| 20 | 405 | 9.62/9.61 | 52.7/52.8 | 9.02/9.08 | 43.6/43.4 | 393.8/393.9 |
| 21 | 405 | 9.66/9.6 | 52.6/52.7 | 9.06/9.05 | 43.7/43.5 | 396.2/393.8 |
| 22 | 405 | 9.75/9.72 | 52.6/52.7 | 9.14/9.12 | 43.6/43.5 | 398.5/396.8 |
| 23 | 405 | 9.72/9.68 | 52.6/52.7 | 9.1/9.11 | 43.6/43.3 | 396.6/394.7 |

Tables 5 and 6 below show a summary of the corrected STC electrical parameters for field measured data for the Bifacial and Frontside-only I-V Curves for the photovoltaic modules tested in this example.

TABLE 5

| | STC | STC | STC | STC | STC |
|---|---|---|---|---|---|
| | Isc (A) | Voc (V) | Imp (A) | Vmp (V) | Pmp (W) |
| maximum | 9.77 | 52.69 | 9.15 | 43.95 | 398.47 |
| minimum | 9.58 | 52.33 | 9.01 | 43.17 | 391.38 |
| Standard | 0.05 | 0.10 | 0.04 | 0.19 | 2.02 |
| deviation | | | | | |
| median | 9.66 | 52.59 | 9.05 | 43.57 | 394.30 |
| Average ± 95% | 9.67 ± 0.02 | 52.55 ± 0.04 | 9.06 ± 0.01 | 43.54 ± 0.08 | 394.62 ± 0.83 |
| conf. int. | | | | | |
| Nameplate | 9.95 | 52.6 | 9.21 | 44 | 405 |
| rating | | | | | |
| Delta from | −2.84% | −0.10% | −1.59% | −1.05% | −2.56% |
| rating | | | | | |

TABLE 6

| | STC | STC | STC | STC | STC |
|---|---|---|---|---|---|
| | Isc (A) | Voc (V) | Imp (A) | Vmp (V) | Pmp (W) |
| maximum | 9.72 | 52.98 | 9.15 | 43.63 | 396.79 |
| minimum | 9.58 | 52.45 | 9.00 | 43.16 | 390.38 |
| Standard | 0.04 | 0.11 | 0.04 | 0.11 | 1.72 |
| deviation | | | | | |
| median | 9.63 | 52.69 | 9.08 | 43.40 | 393.76 |
| Average + 95% | 9.64 ± 0.02 | 52.67 ± 0.05 | 9.08 ± 0.01 | 43.39 ± 0.05 | 393.96 ± 0.7 |
| conf. int. | | | | | |
| Nameplate | 9.95 | 52.6 | 9.21 | 44 | 405 |
| rating | | | | | |
| Delta from | −3.13% | +0.14% | −1.41% | −1.39% | −2.72% |
| rating | | | | | |

Irradiance levels recorded for Bifacial I-V Curve measurements are increased by the rear side irradiance, E_{R,B}, determined for each Bifacial I-V Curve measurement, and temperatures recorded for Frontside-only I-V Curve measurements are increased by the ΔT_{Blackout} determined for each Frontside-only I-V Curve Measurement.

FIG. 12A shows the STC performance of photovoltaic modules based on the Bifacial I-V Curve measurements using the rear side irradiance and temperature adjustment values set forth in Table 3. FIG. 12B shows the STC performance of photovoltaic modules based on the Frontside-only I-V Curve measurements using the rear side irradiance and temperature adjustment values set forth in Table 3. The results show improved alignment after considering the using the rear side irradiance and temperature adjustment values.

While the method and test apparatus have been described in connection with various embodiments, it is to be understood that other similar embodiments may be used, or modifications and additions may be made to the described embodiments for performing the same function. Furthermore, the various illustrative embodiments may be combined to produce the desired results. Therefore, the method and test apparatus should not be limited to any single embodiment, but rather construed in breadth and scope in accordance with the recitation of the appended claims. It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A method of measuring the power delivery performance in-situ of a bifacial photovoltaic device installed in the field having a front surface and a rear surface, the method comprising:
(a-1) removably attaching a substantially non-reflective surface on the rear surface of the bifacial photovoltaic device; or
(a-2) arranging the substantially non-reflective surface near the rear surface of the bifacial photovoltaic device; and
(b) measuring the power delivery performance of the bifacial photovoltaic device.

2. The method of measuring the power delivery performance of a bifacial photovoltaic device of claim 1, wherein the photovoltaic device is selected from the group consisting of single photovoltaic cell, a photovoltaic module comprising more than one electrically connected photovoltaic cells, or a photovoltaic panel comprising more than one electrically connected photovoltaic modules.

3. The method of measuring the power delivery performance of a bifacial photovoltaic device of claim 2, wherein the photovoltaic device comprises a photovoltaic module comprising more than one electrically connected photovoltaic cells arranged in a plane.

4. The method of measuring the power delivery performance of a bifacial photovoltaic device of claim 3, wherein the photovoltaic device comprises a photovoltaic panel comprising more than one electrically connected photovoltaic modules arranged in a plane.

5. The method of measuring the power delivery performance of a bifacial photovoltaic device of claim 1, wherein the non-reflective surface comprises more than one interlocked sub-units.

6. The method of measuring the power delivery performance of a bifacial photovoltaic device of claim 1, wherein the perimeter of the non-reflective surface is substantially coextensive with the perimeter of the rear surface of the bifacial photovoltaic device.

7. The method of measuring the power delivery performance of a bifacial photovoltaic device of claim 1, wherein the non-reflective surface is positioned in contact with the rear surface of the bifacial photovoltaic device.

8. The method of measuring the power delivery performance of a bifacial photovoltaic device of claim 7, wherein there is no gap between the non-reflective surface and the rear surface of the bifacial photovoltaic device.

9. The method of measuring the power delivery performance of a bifacial photovoltaic device of claim 1, wherein the there is no baffle surrounding the perimeter of the bifacial photovoltaic device.

10. The method of measuring the power delivery performance of a bifacial photovoltaic device of claim 1, comprising:
conducting a first measurement of the current and voltage characteristics of the bifacial photovoltaic device without the non-reflective surface applied thereto;
applying the non-reflective surface to the rear side of the bifacial photovoltaic device or arranging the substantially non-reflective surface near the rear surface of the bifacial photovoltaic device; and
conducting a second measurement of the current and voltage characteristics of the bifacial photovoltaic device after applying the non-reflective surface to the rear side of the bifacial photovoltaic device.

11. The method of measuring the power delivery performance of a bifacial photovoltaic device of claim 10, wherein the time lapse between conducting the first measurement of the current and voltage characteristics of the bifacial photovoltaic device and conducting the second measurement of the current and voltage characteristics of the bifacial photovoltaic device is selected from the group consisting of 10 minutes or less, 5 minutes or less, 4 minutes or less, 3 minutes or less, 2 minutes or less and 1 minute or less.

12. The method of measuring the power delivery performance of a bifacial photovoltaic device of claim 11, wherein the time lapse between conducting the first measurement of the current and voltage characteristics of the bifacial photovoltaic device and conducting the second measurement of the current and voltage characteristics of the bifacial photovoltaic device is 5 minutes or less.

13. The method of measuring the power delivery performance of a bifacial photovoltaic device of claim 11, wherein the temperature of the module under test is determined by comparing the Voc of the bifacial photovoltaic device with the non-reflective surface applied thereto with the Voc of the bifacial photovoltaic device without the non-reflective surface applied thereto.

14. The method of measuring the power delivery performance of a bifacial photovoltaic device of claim 1, wherein the non-reflective surface absorbs at least 75% of visible light, or at least 80% of visible light, or at least 85% of visible light, or at least 90% of visible light, or at least 95% of visible light, or at least 96% of visible light, or at least 97% of visible light, or at least 98% of visible light, or at least 99% of visible light, or at least 99.1% of visible light, or at least 99.2% of visible light, or at least 99.3% of visible light, or at least 99.4% of visible light, or at least 99.5% of visible light.

15. The method of measuring the power delivery performance of a bifacial photovoltaic device of claim 1, wherein the non-reflective surface absorbs at least 75% of ultra-violet light, or at least 80% of ultra-violet light, or at least 85% of ultra-violet light, or at least 90% of ultra-violet light, or at least 95% of ultra-violet light, or at least 96% of ultra-violet light, or at least 97% of ultra-violet light, or at least 98% of ultra-violet light, or at least 99% of ultra-violet light, or at least 99.1% of ultra-violet light, or at least 99.2% of ultra-violet light, or at least 99.3% of ultra-violet light, or at least 99.4% of ultra-violet light, or at least 99.5% of ultra-violet light.

16. The method of measuring the power delivery performance of a bifacial photovoltaic device of claim 1, wherein the non-reflective surface absorbs at least 95% of visible light and at least 95% of ultraviolet light, or at least 96% of visible light and at least 96% of ultraviolet light, or at least 97% of visible light and at least 97% of ultraviolet light, or at least 98% of visible light and at least 98% of ultraviolet light, or at least 99% of visible light and at least 99% of ultraviolet light, or at least 99.5% of visible light and at least 99.5% of ultraviolet light.

17. The method of measuring the power delivery performance of a bifacial photovoltaic device of claim 1, wherein the non-reflective surface absorbs at least 75% of infrared light, or at least 80% of infrared light, or at least 85% of infrared light, or at least 90% of infrared light, or at least 95% of infrared light, or at least 96% of infrared light, or at least 97% of infrared light, or at least 98% of infrared light, or at least 99% of infrared light, or at least 99.1% of infrared light, or at least 99.2% of infrared light, or at least 99.3% of infrared light, or at least 99.4% of infrared light, or at least 99.5% of infrared light.

18. The method of measuring the power delivery performance of a bifacial photovoltaic device of claim 1, wherein the non-reflective surface reduces the irradiance at the rear surface of the photovoltaic device to less than 1%, or less than 0.9%, or less than 0.8%, or less than 0.75%, or less than 0.7%, or less than 0.6%, or less than 0.5%, or less than 0.4%, or less than 0.3%, or less than 0.25%, or less than 0.2% or less than 0.1% of the irradiance of the front surface of the photovoltaic device.

19. A method of measuring the power delivery performance of a bifacial photovoltaic device comprising:
measuring the in-situ measured power delivery performance of a bifacial photovoltaic device installed in the field and operating, and
comparing the in-situ measured power delivery performance of the photovoltaic device to the power delivery performance of the photovoltaic device measured at the manufacturing facility.
